(19) United States
(12) Patent Application Publication
(10) Pub. No.: US 2008/0276644 A1
(43) Pub. Date: Nov. 13, 2008

(54) Domestic appliance with a cooling apparatus

(76) Inventors: Heinz-Dieter Eichholz, Iserlohn (DE); Georg Pfitzer, Weingarten (DE); Bernd Geser, Wasserburg (DE)

Correspondence Address: WILLIAM D. BRENEMAN, ESQ.;BRENEMAN & GEORGES, 3150 COMMONWEALTH AVENUE, ALEXANDRIA, VA, 22305, US

(21) Appl. No.: 12/149,941

(22) Filed: May 9, 2008

(30) Foreign Application Priority Data
May 11, 2007 (DE) DE 102007022697.9
Oct. 11, 2007 (DE) DE 102007049053.6
Nov. 13, 2007 (DE) DE 102007054449.0

(51) Int. Cl. F25B 15/00; F25B 39/02; B08B 3/00; D06F 37/00; D06F 58/00

(52) U.S. Cl. 62/476; 62/515; 134/58 D; 68/5 C; 34/108

(57) ABSTRACT

The invention proposes a domestic appliance having a cooling unit with a sorbent from which a refrigerant can be separated by the application of energy, having a condensation unit for condensing the separated refrigerant, and a cooling unit for dispensing the cold of evaporation of the evaporated refrigerant, and having a control unit for temporally separately controlling the application of energy to the sorbent for separating the refrigerant from the sorbent firstly at a first time and dispensing cold by evaporating refrigerant in the cooling unit at another time, characterized in that the cooling unit is in the form of a physical unit which is separate from the condensation unit and is connected to the said condensation unit via a refrigerant-carrying line.

The invention relates to a domestic appliance having a cooling apparatus according to the preamble of claim 1.

In many domestic appliances such as dishwashers, tumble dryers or the like, a cooling process is often advantageous, at least as a subprogram step, in addition to other operating processes.

For example, in beverage machines such as espresso machines or the like, it may be expedient to cool a hot beverage in order to provide a beverage which has been prepared hot as a cold beverage, for example as iced coffee.

Cooling units are also advantageous for drying processes since moisture from the air can be condensed by the said cooling units. In a tumble dryer, the entire operating process is, for example, a drying process, but in a machine such as a dishwasher or a washing machine with an integrated drying system, drying is generally provided as a subprogram step at the end of a program sequence.

Various options have been disclosed for drying, in particular, washware in a dishwasher.

For example, the washware can be dried by its inherent heat when the washware is washed at such a high temperature in the last wash cycle, generally a final-rinse cycle, that the washware subsequently dries quickly on its own.

On account of the large amount of heat transferred to the washware, the residual water remaining on the washware after the wash cycle evaporates and condenses on colder surfaces and/or is actively expelled from the dishwasher.

In addition, separate heating apparatuses for drying purposes, for example in the form of hot-air fans or the like, are known for heating the air mixture provided for drying purposes and therefore increasing the moisture-absorption capacity of the said air mixture.

In all these cases, a high energy requirement is associated with drying.

A domestic appliance of this type has been disclosed, for example, in WO 2005/053503. This document describes a dishwasher in which a cooling unit is used to dry wet dishes. This cooling unit has a solids store and a storage reservoir for condensed refrigerant, which store and storage reservoir are connected by means of a connection line. When the sorbent is heated in the sorption container, the refrigerant flows into the refrigerant store in gaseous form and condenses there. At a later time, at which the sorption container and the sorbent contained in it are cooled, the refrigerant flows back into the sorbent, again in gaseous form, through the same connection line in the opposite direction of flow, with the refrigerant store and its surroundings being cooled by the cold of evaporation.

Although refrigerant which is condensed with a design of this type can be stored as a cold reservoir, the efficiency of this cooling unit is structurally limited on account of the use of the refrigerant store as a cooler.

The object of the invention is to propose a domestic appliance having a cooling unit in which this disadvantage is eliminated.

Taking a domestic appliance of the type described in the introduction as a starting point, this object is achieved by the characterizing features of claim 1.

Accordingly, an inventive domestic appliance having a cooling apparatus is distinguished in that the cooling unit for dispensing the cold produced by cold of evaporation is in the form of a physical unit which is separate from the condensation unit and is connected to the said condensation unit via a refrigerant-carrying line.

In this way, it is possible to structurally configure and arrange the cooling unit such that more efficient utilization of cold is possible. In particular, a cooling unit with a comparatively large surface can be used. In addition, the cooling unit can be arranged, that is to say positioned, in the domestic appliance independently of the location of the condensation unit.

This may be advantageous particularly in cases where, in a region of the domestic appliance which is to be cooled at a later point in time, the process is initially run at relatively high temperatures during operation, as is the case, for example, in the working chamber of a dishwasher. If, during operation of a domestic appliance of this type, the refrigerant has to be expelled from the sorbent and stored in condensed form in a refrigerant store at the same time, it is necessary, for the purpose of condensation in the condensation unit, to thermally separate corresponding heat sources, for example the interior of a dishwasher, at this time for the purpose of efficient condensation of the expelled coolant. In the case of a separate cooling unit, it does not matter at this time if the said cooling unit is in thermally-conductive contact with a surrounding area, for example with the wall of a washing chamber of a dishwasher, which is warm at this time but is to be cooled later. In contrast, the condensation unit can be accommodated, independently of the cooling unit, in a surrounding area where it is possible to dispense a sufficient amount of heat for condensation of the refrigerant. In terms of the structural configuration, in particular in terms of the shape, it is also possible to adapt the functions of the condensation unit independently of the cooling unit.

The refrigerant can then flow from the condensation unit to the cooling unit only at a later time at which cooling is desired, it being possible for the cooling unit to be cooled and the resulting cold to be dispensed for the corresponding use on account of evaporation of the condensed refrigerant. Therefore, for example at such a later time, the inner wall of a dishwasher chamber can be cooled in order to condense moisture. In a special embodiment, the cooling unit can also be arranged in the washing chamber of a dishwasher for this purpose.

The structural configuration of the cooling unit is also significantly more flexible when the condensation unit is separate, that is to say different designs for the cooling unit can be used in this case, in particular designs which are less suitable for operation as refrigerant store.

After the refrigerant is expelled from the sorption container, the condensation unit is advantageously separated from the said sorption container. To this end, a shut-off valve is advantageously provided in the connection line between the sorption container and the condensation unit. In the case of a liquid sorbent, this connection line is used at least partially as a rectification section in order to separate liquid refrigerant from liquid sorbent. In this case, the shut-off valve is preferably fitted downstream of the rectification section as seen in the direction of flow. When the cooling unit and the sorption unit or refrigerant store are separated as per the invention, a shut-off valve of this type may simply be in the form of a non-return valve.

Furthermore, a control valve is preferably provided in order to separate the condensation unit from the sorbent and connect the said condensation unit to the sorbent at the desired time. If this control valve is closed, condensed refrigerant remains in the condensation unit which, as a result, forms a kind of cold reservoir. If the control valve is switched over to the open state, the refrigerant flows back to the sorbent, with the flow path leading across the separate cooling unit in accordance with the invention.

The sorbents used may be both solid sorbents and liquid sorbents. Examples of solid sorbents include zeolite, calcium chloride, strontium chloride or the like. The refrigerant used for zeolite may be, for example, water, and the refrigerant used for calcium chloride or strontium chloride may be ammonia. A good liquid sorbent when ammonia is used as refrigerant is present, for example, in the form of water. A lithium bromide solution can also be used in conjunction with the refrigerant water as a liquid sorbent.

To this end, the cooling unit is advantageously connected to the sorbent or to the sorption container via a return line for refrigerant. The sorption container is therefore provided with at least two connections, that is to say a refrigerant output and a refrigerant inlet, with the output being connected to the condensation unit and the input being connected to the cooling unit.

As already mentioned above, the cooling unit can be of structurally flexible form when configured separately as per the invention. By way of example, refinements as cooling coils or in the form of a finned cooler are feasible. In particular, a very flat construction which can be readily joined to the wall of a working chamber is feasible in both variants.

In another embodiment, the cooling unit has a conventional heat exchanger, for example in the form of a countercurrent heat exchanger.

As already indicated, the condensation unit is advantageously formed such that it comprises a reservoir container for condensed refrigerant, so that a cold reservoir is created when the condensation unit is sealed off. In a particular embodiment, a reservoir container of this type may be in the form of a tube section, possibly in coil form. The configuration of the condensation unit with tube coils as a reservoir container simplifies cooling of the refrigerant expelled from the sorbent by heat being supplied, and therefore simplifies condensation. As a result, it is possible, depending on the design, to dispense enough heat to the surrounding area, so that additional cooling, for example by means of a fan, by fresh water or the like, is not necessary.

Since a cooling apparatus according to the invention does not require a continuous refrigerant circuit on account of the application of energy to the sorbent for separating refrigerant not being coupled in terms of time to the time at which cold is tapped off from the cooling unit, the path into the condensation unit is in the form of a blind passage, for example a blind line, in a particular embodiment of the invention.

A refinement of this kind provides additional structural freedom in terms of arrangement and configuration of the condensation unit. For example, evaporated refrigerant can flow up to the condensation unit from below, so that newly entering gaseous refrigerant passes liquid refrigerant as it passes upwards within the condensation unit, and the condensation process can be improved as a result. Furthermore, in this embodiment, the refrigerant can be discharged from the condensation unit at the lower end again at the time at which cold is dispensed, so that the flow of refrigerant is assisted by gravity.

On account of the structural separation of the condensation unit and the cooling unit, not only different designs, but also different quantitative ratios, for example different volumes, can be used when configuring the cooling unit in comparison to the condensation unit. By way of example, the condensation unit may be configured in terms of the required holding capacity, whereas, in contrast, the cooling unit can be designed in terms of the required surface for heat transfer given a corresponding volumetric flow of refrigerants. Therefore, for example, both the condensation unit and the cooling unit may be present in the form of tube lines which, however, have different diameters.

The invention can be advantageously used primarily where the requirement for cold can occur at a different time to that at which heat is applied to the sorbent, since a cold reservoir is cyclically stored in the form of a specific volume of condensed refrigerant. In addition to the described drying processes, use is also feasible, inter alia, in beverage machines in which beverages which are prepared hot are subsequently cooled, for example in coffee or espresso machines for preparing “cold coffee”. In principle, the invention can advantageously be used in domestic appliances, with cooling cold for cooling operating media and/or articles being, in particular spontaneously or indirectly and/or briefly, required or requested or called up from a cold store or the cooling unit. This may be of particular advantage both in the applications already mentioned above and also, for example, for rapidly cooling bottles of wine, medicinal cool packs etc. in refrigerators or the like.

Various exemplary embodiments of the invention are explained in greater detail below and illustrated in the drawing in which, in detail,

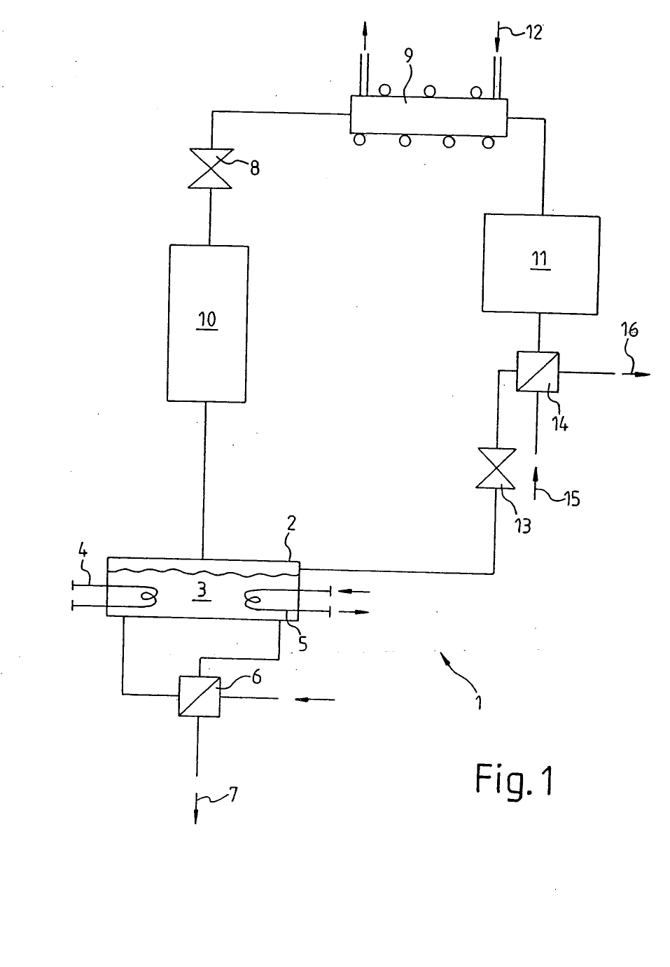

FIG. 1 shows a schematic block diagram of a cooling apparatus of a domestic appliance according to the invention,

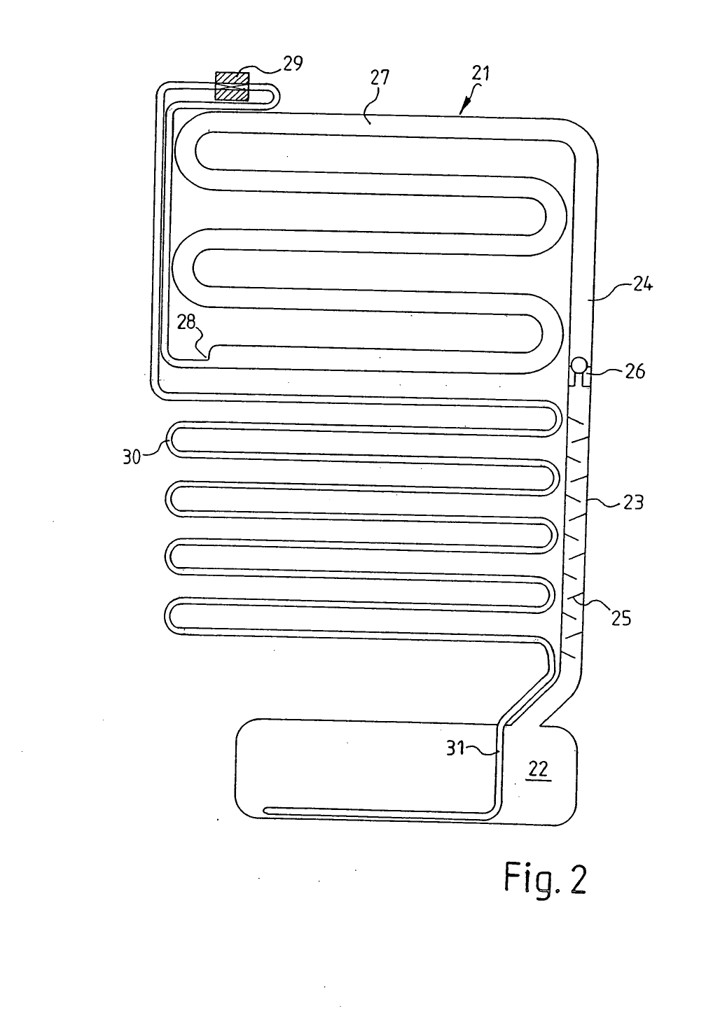

FIG. 2 shows a schematic diagram of a second embodiment variant of a cooling apparatus according to the invention, and

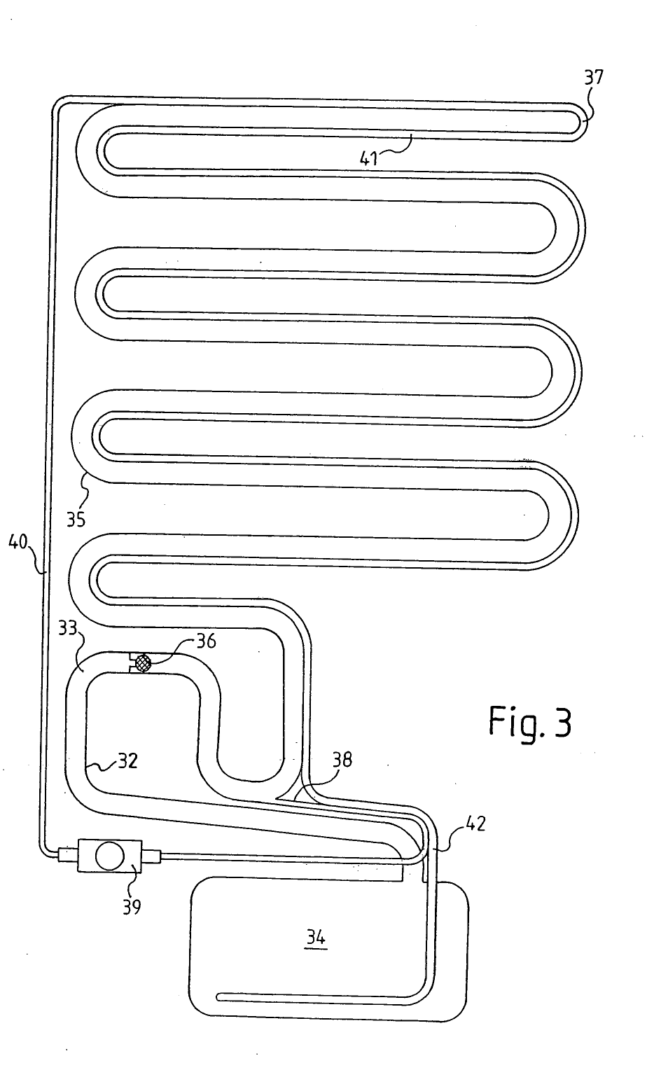

FIG. 3 shows a schematic diagram of a third embodiment variant.

The cooling apparatus 1 according to the figure comprises a sorption container 2 in which a mixture 3 of sorbent and refrigerant is filled in liquid form.

Heat can be supplied to this mixture of sorbent and refrigerant in order to cause the refrigerant to desorb. In the present diagram, three different ways of supplying heat are illustrated by way of example.

For example, it is possible to heat the sorbent/refrigerant mixture 3 by means of an electrical heating coil 4 which protrudes into the liquid in the sorption container 2 in the manner of an immersion heater. In this case, the heating coil 4 can heat the sorbent/refrigerant mixture only locally but, on account of the liquid property, uniform heat distribution is nevertheless provided due to convection. Heat distribution can optionally be assisted by a stirring or pumping element.

Another potential way of supplying heat is a fluid tube coil 5 which, in principle, is designed like the electrical heating coil 4 but comprises a hollow tube, so that a hot fluid, for example a working fluid from operation of the domestic appliance, can be supplied in a heated state, so that the sorbent/refrigerant mixture 3 is heated in this way. On account of heating of this kind, it is possible to use the process heat from operation of the domestic appliance for operation of the refrigeration unit.

A third heating alternative is provided by means of an external heat exchanger 6 by means of which the liquid sorbent/refrigerant mixture is recirculated. On account of the heat exchanger 6, a working fluid 7 can again be used for supplying heat. A working fluid 7 of this type is indicated by an arrow. In this case, a heating medium which is provided solely for this purpose can be used in conjunction with the heat exchanger 6 in order to heat the sorbent/refrigerant mixture.

All the described heating variants can be used as alternatives or in combination, at the same time or in sequence, and therefore provide a variety of ways of utilizing the process heat of the domestic appliance during operation.

When the sorbent/refrigerant mixture is heated, either refrigerant in pure form or a highly concentrated mixture of sorbent and refrigerant, depending on the materials selected, is evaporated and enters a cooler 9 via a shut-off valve 8. A distillation column 10 can optionally be interposed in order to concentrate a sorbent/refrigerant mixture, which is expelled from the sorption container 2, in steps.

Therefore, either refrigerant in pure form or a sorbent/refrigerant mixture with a high concentration of refrigerant enters the cooler 9. On account of the cooling, condensation is initiated in the cooler 9, so that the concentrated mixture or the pure refrigerant can be collected in a refrigerant container 11 in liquid form. A cooling fluid 12 which, for example, is suitable for further utilizing the waste heat, can be used to cool the cooler 9. Instead of this, fresh water, for example, can be used in order to utilize the heat of desorption which is drawn during the cooling process in order to preheat the cooling water.

The refrigerant container 11 can be separated from the sorbent container 2 by means of a further shut-off valve 13, so that the refrigerant which is present in liquid form in the refrigerant container 11 can be stored as a cold store when the shut-off valve 13 is closed.

The sorbent or the mixture, which has a depleted content of refrigerant, of sorbent and refrigerant 3 in the sorbent container 2 can be cooled in this working step, it being possible to effect this, for example, once again by using the heat exchanger 6 in conjunction with a cooling fluid. On account of the liquid form of the sorbent or of the sorbent/refrigerant mixture, this sorbent or sorbent/refrigerant mixture can also be recirculated for cooling by means of a heat exchanger 6 or a cooler. However, a cooling fluid can also be recirculated for cooling purposes by means of a cooling coil which protrudes into the sorption container 2, or can be used across the container wall of the sorption container 2. In this case, the cooling coil used may be, for example, the fluid tube coil 5 which was previously used as a heating coil.

Furthermore, a further heat exchanger 14 is illustrated between the refrigerant container 11 and the sorption container 2, the said heat exchanger forming the cooling unit and, for example, possibly being in the form of a cooler for a hot-air stream 15 when the shut-off valve 13 is open. The hot air 15 can be drawn, for example, from the interior of a domestic appliance in a suitable manner, for example by means of a fan, and conducted by means of the heat exchanger 14 which is used as a cooler. The resulting condensate can be discharged, or, as indicated further above, be used for fresh-water conditioning or simply to supplement the processing-water requirement. The dry cold-air stream 16 can optionally be heated again using the heat of sorption generated during dissolution of the refrigerant in the sorbent 3. Therefore, the cold-air stream 16 can be conducted, for example via the fluid tube coil 5 and/or the heat exchanger 6, so that said cold-air stream is reheated using the heat of sorption. This heated dry air stream is most highly suited to drying wet, cleaned articles, for example washware in a dishwasher.

It goes without saying that other heat exchangers, which operate independently of one another, can also be provided for the different fluid streams, in order to make use of the waste heat, which is produced in individual method steps, from the cooling unit 1 or in order to use process heat from operation of the domestic appliance for the cooling unit 1.

Furthermore, all the above-described ways of discharging waste heat or supplying process heat in conjunction with the sorbent/refrigerant mixture 3 in the sorption container 2 can also be used in the region of the distillation column 10.

The embodiment variant according to FIG. 2 corresponds substantially to the abovementioned exemplary embodiment, but its structure is considerably simplified. This design is distinguished particularly in that it can be very flat, so it can be fitted to a side wall of the working chamber of a domestic appliance.

The cooling apparatus 21 according to FIG. 2 comprises, like the abovementioned exemplary embodiment, a sorption container 22 which, depending on the operating state, contains a sorbent/refrigerant mixture in an enriched or depleted state.

The sorbent/refrigerant mixture contained in the sorption container 22 can be heated by heating means (not illustrated in any detail). As a result, the refrigerant can evaporate and escape into the rectification region 23 of a tube line 24. In the present embodiment, the rectification region 23 is provided with baffles 25 on which co-evaporated sorbent can condense and flow back, so that separation of sorbent and refrigerant in the rectification region 23 is improved. The rectification region 23 accordingly corresponds, in terms of function, to the distillation column 10 of the above-described exemplary embodiment.

A non-return valve 26 separates the rectification region 23 from the following condensation unit 27 which is in the form of a subregion of the tube line 24. The condensation unit is of serpentine construction and is provided with a cross-sectionally tapered portion 28 in its end region. A switchover valve 29 limits the condensation unit 27 and interrupts the connection between the said condensation unit and the sorption container 22 in the direction of flow of the refrigerant. The tube line 24 accordingly forms the refrigerant container, which is present in the abovementioned exemplary embodiment, between the non-return valve 26 and the switchover valve 29. In the illustrated exemplary embodiment, the refrigerant is condensed by heat being dispensed to the surrounding area without active cooling. However, active cooling can be readily provided in this region, for example by fresh water, if required.

The switchover valve 29 is followed by a cooling unit 30 in the form of a subsection of the tube line 24 which is arranged substantially beneath the condensation region and is likewise of serpentine form. The tube line 24 ends by way of an end piece 31 downstream of the evaporator region 30 in the sorption container 22. The cooling unit is cooled by evaporated or cold, pre-evaporated refrigerant and can dispense the cold thus produced.

This embodiment variant is structurally already considerably simplified compared to the first exemplary embodiment. All circulation of the refrigerant takes place in a single tube line. In order to operate this cooling apparatus 21, it is necessary to perform only two control operations which can be decoupled from one another in terms of time. In first instance, it is necessary to heat the refrigerant/sorption mixture in the sorption container 22 in order to expel the refrigerant. Condensed refrigerant is then available in the condensation unit 27 in the form of a cold store. The switchover valve 29 can be opened at the desired time, in a manner decoupled in terms of time from the heating process, so that the refrigerant can escape in the direction of the sorption container 22 and in the process can be used, with evaporation, for cooling purposes in the cooling unit 30.

This embodiment variant is accordingly highly simplified compared to the first exemplary embodiment not only in terms of the structural design, but also in terms of the outlay on control.

The embodiment variant according to FIG. 3 again has a rectification region 32 of a tube line 33 which branches off from a sorption container 34. The rectification region 32 again merges with a condensation unit 35, which is in the form of a tube line and is again of serpentine construction, via a non-return valve 36.

In a departure from the abovementioned exemplary embodiment, the condensation unit 35 ends in the form of a blind passage at its upper end 37. In this exemplary embodiment, the condensation unit 35 is accordingly filled from below, that is to say pre-condensed refrigerant assists the condensation process as gaseous refrigerant which is expelled from the sorption container 34 by heating means (not illustrated in any detail) passes through.

A cooling line 38, which issues into a riser line 40 via a switchover valve 39, branches off in the lower region, that is to say at the lowest point of the condensation unit 35 in the illustrated embodiment. The riser line 40 is already part of a cooling unit 41 which is tubular and in which the refrigerant evaporates. The cooling unit 41 nestles against the serpentine condensation unit 35. The said cooling unit issues into an outflow line 42 in the sorption container 34. This embodiment variant can again be of very flat and at the same time comparatively low construction. The branching-off cooling line 38 with a reduced cross section is now provided in place of the cross-sectionally tapered portion 28.

In this embodiment variant, the evaporation process is assisted by liquid refrigerant being forced into the riser line 40 of the cooling unit 41 under the action of gravity. By virtue of the resulting cooling effect of the condensation unit 35 on account of the thermal contact between the cooling unit 41 and the condensation unit 35, any other gaseous residues of refrigerant are condensed out in the upper region of the condensation unit 35 at the same time. Therefore, the condensation unit 35 is virtually completely emptied, as a result of which the existing refrigerant is utilized highly efficiently.

The embodiment variant according to FIG. 3 can accordingly be implemented to be even more compact than the embodiment variant according to FIG. 2 with a comparable cooling power. Both cases involve a substantially closed tube system, so that the requirements for leak-tightness can be easily fulfilled.

The embodiment variant according to FIG. 3 makes use of the situation that, in a cooling apparatus according to the invention, the time at which the refrigerant is expelled from the sorption container 34 by heating is decoupled in terms of time from the time of the desired cooling. The variant according to FIG. 3 accordingly does not exhibit a closed circuit comprising a rectification region, condensation unit and cooling unit. Instead, the temporal decoupling between application of heat and cooling is utilized to the effect that it is possible to reverse the direction of flow in the condensation unit 35. Filling of the condensation unit 35 when refrigerant is expelled from the sorbent is accordingly performed in the opposite direction to emptying into the cooling unit.

The inventive separation of cooling unit and condensation unit by the interposed refrigerant-carrying connection is important in all the embodiments of the invention.

### LIST OF REFERENCE SYMBOLS

1 Cooling apparatus
2 Sorption container
3 Sorbent/refrigerant
4 Heating coil
5 Fluid tube coil
6 Heat exchanger
7 Heating fluid
8 Shut-off valve
9 Cooler
10 Distillation column
11 Refrigerant container
12 Cooling fluid
13 Shut-off valve
14 Heat exchanger
15 Hot air
16 Cold-air stream
21 Cooling apparatus
22 Sorption container
23 Rectification region
24 Tube line
25 Baffle
26 Non-return valve
27 Condensation unit
28 Cross-sectionally tapered portion
29 Switchover valve
30 Cooling unit
31 End piece
32 Rectification region
33 Tube line
34 Sorption container
35 Condensation unit
36 Non-return valve
37 End
38 Cooling line
39 Switchover valve
40 Riser line
41 Cooling unit
42 Outflow line

What is claimed is:

1. Domestic appliance having a cooling apparatus with a sorbent from which a refrigerant can be separated by the application of energy, having a condensation unit for condensing the separated refrigerant, and a cooling unit for dispensing the cold of evaporation of the evaporated refrigerant, and having a control unit for temporally separately controlling the application of energy to the sorbent for separating the refrigerant from the sorbent firstly at a first time and dispensing cold by evaporating refrigerant in the cooling unit at another time, characterized in that the cooling unit is in the form of a physical unit which is separate from the condensation unit and is connected to the said condensation unit via a refrigerant-carrying line.

2. Domestic appliance according to claim 1, characterized in that a control valve is provided between the condensation unit and the sorbent.

3. Domestic appliance according to either of the preceding claims, characterized in that a solid sorbent is provided.

4. Domestic appliance according to one of the preceding claims, characterized in that a liquid sorbent is provided.

5. Domestic appliance according to one of the preceding claims, characterized in that a rectification unit is provided between the condensation unit and the sorption unit in order to separate refrigerant and sorbent.

6. Domestic appliance according to one of the preceding claims, characterized in that the rectification unit is in the form of a tube line.

7. Domestic appliance according to one of the preceding claims, characterized in that the cooling unit is connected to the sorption unit via a return line for refrigerant.

8. Domestic appliance according to one of the preceding claims, characterized in that the cooling element is in the form of a cooling coil or a finned cooler or a countercurrent heat exchanger.

9. Domestic appliance according to one of the preceding claims, characterized in that the condensation unit comprises a reservoir container for condensed refrigerant.

10. Domestic appliance according to one of the preceding claims, characterized in that the reservoir container is in the form of a tube.

11. Domestic appliance according to one of the preceding claims, characterized in that the condensation unit is in the form of tube coil.

12. Domestic appliance according to one of the preceding claims, characterized in that the condensation unit is in the form of blind passage.

13. Domestic appliance according to one of the preceding claims, characterized in that a valve is provided between the condensation unit and the rectification unit.

14. Domestic appliance according to one of the preceding claims, characterized in that the valve between the condensation unit and rectification unit is a non-return valve.

15. Dishwasher, characterized in that it is in the form of a domestic appliance according to one of the preceding claims.

16. Washing machine, characterized in that it is in the form of a domestic appliance according to one of the preceding claims.

17. Tumble dryer, characterized in that it is in the form of a domestic appliance according to one of the preceding claims.

18. Beverage machine, in particular espresso machine, characterized in that it is in the form of a domestic appliance according to one of the preceding claims.
